(19) United States
(12) Patent Application Publication
(10) Pub. No.: US 2007/0078576 A1
(43) Pub. Date: Apr. 5, 2007

(54) System and method for fuzzy-logic based fault diagnosis

(76) Inventors: Mutasim A. Salman, Rochester Hills, MI (US); Pierre-Francois D. Quet, Madison Heights, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/243,058

(22) Filed: Oct. 4, 2005

(51) Int. Cl. G06F 19/00

(52) U.S. Cl. 701/29; 340/438

(57) ABSTRACT

A system and method for monitoring the state of health of sensors, actuators and sub-systems in an integrated vehicle control system. The method includes identifying a plurality of potential faults, identifying a plurality of measured values, and identifying a plurality of estimated values based on models in the control system. The method further includes identifying a plurality of residual error values as the difference between the estimated values and the measured values. The method also defines a plurality of fuzzy logic membership functions for each residual error value. A degree of membership value is determined for each residual error value based on the membership functions. The degree of membership values are then analyzed to determine whether a potential fault exists.

### BACKGROUND OF THE INVENTION

1. Field of the Invention

This invention relates generally to a method for monitoring the state of health and providing fault diagnosis for the components in an integrated vehicle stability system and, more particularly, to a fuzzy-logic based state of health and fault diagnosis monitoring system for a vehicle employing an integrated stability control system.

2. Discussion of the Related Art

Diagnostics monitoring for vehicle stability systems is an important vehicle design consideration so as to be able to quickly detect system faults, and isolate the faults for maintenance purposes. These stability systems typically employ various sensors, including yaw rate sensors, lateral acceleration sensors and steering hand-wheel angle sensors, that are used to help provide the stability control of the vehicle. For example, certain vehicle stability systems employ automatic braking in response to an undesired turning or yaw of the vehicle. Other vehicle stability systems employ active front-wheel or rear-wheel steering that assist the vehicle operator in steering the vehicle in response to the detected rotation of the steering wheel. Other vehicle stability systems employ active suspension stability systems that change the vehicle suspension in response to road conditions and other vehicle operating conditions.

If any of the sensors, actuators and sub-systems associated with these stability systems fail, it is desirable to quickly detect the fault and activate fail-safe strategies so as to prevent the system from improperly responding to a perceived, but false condition. It is also desirable to isolate the defective sensor, actuator or sub-system for maintenance and replacement purposes, and also select the proper fail-safe action for the problem. Thus, it is necessary to monitor the various sensors, actuators and sub-systems employed in these stability systems to identify a failure.

### SUMMARY OF THE INVENTION

In accordance with the teachings of the present invention, a system and method for monitoring the state of health of sensors, actuators and sub-systems in an integrated vehicle control system is disclosed. The method includes identifying a plurality of potential faults, such as faults relating to a lateral acceleration sensor, a yaw rate sensor, a road wheel angle sensor and wheel speed sensors. The method further includes identifying a plurality of measured values, such as from the yaw rate sensor, the vehicle lateral acceleration sensor, the road wheel angle sensors and the wheel speed sensors. The method further includes identifying a plurality of estimated values based on models, such as estimated or anticipated output values for the yaw rate, lateral acceleration, road wheel angle and wheel speeds. The method further includes identifying a plurality of residual error values as the difference between the estimated values and the measured values. The method also defines a plurality of fuzzy logic membership functions for each residual error value. A degree of membership value is determined for each residual error value based on the membership functions. The degree of membership values are then analyzed to determine whether a potential fault exists.

Additional features of the present invention will become apparent from the following description and appended claims taken in conjunction with the accompanying drawings.

### BRIEF DESCRIPTION OF THE DRAWINGS

FIG. 1 is a flow chart diagram showing a process for monitoring the state of health of sensors, actuators and sub-systems used in an integrated vehicle stability control system, according to an embodiment of the present invention;

FIG. 2 is a block diagram showing a process for generating residuals for the process of the invention; and

FIGS. 3a-3d are graphs showing fuzzy logic membership functions for the residuals.

### DETAILED DESCRIPTION OF THE EMBODIMENTS

The following discussion of the embodiments of the invention directed to a system and method for monitoring the state of health of sensors, actuators and sub-systems in an integrated vehicle stability control system using fuzzy logic analysis is merely exemplary in nature, and is in no way intended to limit the invention or its applications or uses.

The present invention includes an algorithm employing fuzzy logic for monitoring the state of health of sensors, actuators and sub systems that are used in an integrated vehicle stability control system. The vehicle stability integrated control system may employ a yaw rate sensor, a vehicle lateral acceleration sensor, a vehicle wheel speed sensor and road wheel angle sensors at the vehicle level. The integrated control system may further include active brake control sub-systems, active front and rear steering sub-systems and semi-active suspension sub-systems. Each component and sub-system used in the integrated vehicle stability control system employs its own diagnostic sensors and monitoring, where the diagnostic signals are sent to a supervisory monitoring system. The supervisory system collects all of the information from the sub-systems and the components, and uses information fusion to detect, isolate and determine the faults in the stability control system.

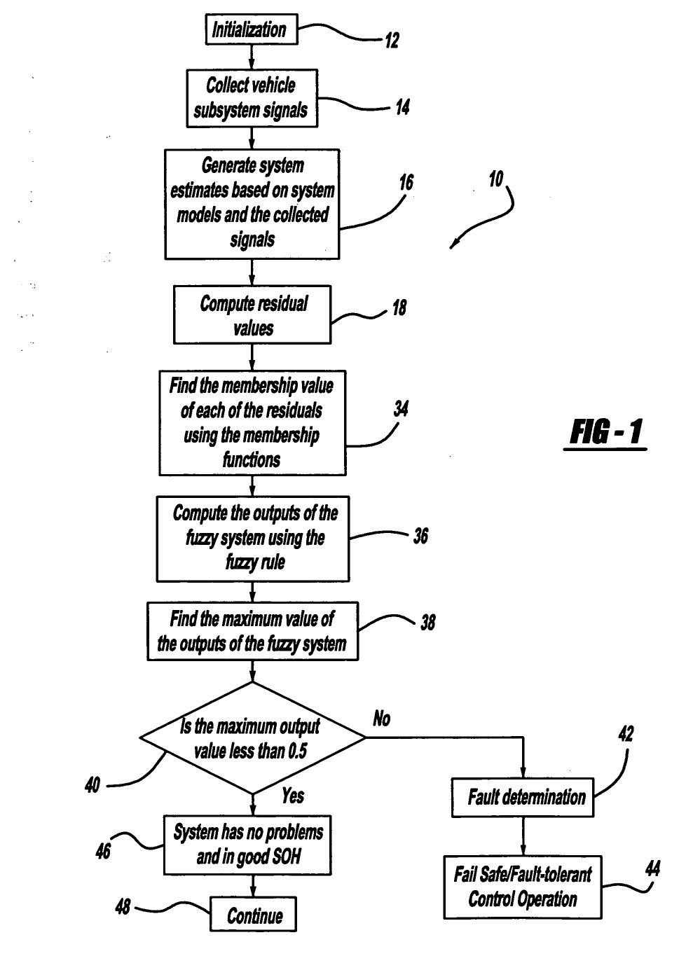

FIG. 1 is a flow chart diagram 10 showing a process for monitoring the state of health of sensors, actuators and sub-systems employed in an integrated vehicle stability control system, according to an embodiment of the present invention. The system parameters are initialized at box 12. Each component and sub-system includes its own diagnostics provided by the component supplier that is checked by the algorithm of the invention in a supervisory manner. The supervisory diagnostics algorithm collects the diagnostics signals from the sub-systems and the components at box 14, and can receive controller area network (CAN) or FlexRay communications signals from the components and the sub-systems. At this point of the process, various signal processing has already been performed, including, but not limited to, sensor calibration and centering, limit checks, reasonableness of output values and physical comparisons.

The algorithm then estimates the control system behavior using predetermined models at box 16. In one non-limiting embodiment, the system behavior is estimated when the speed of the vehicle is greater than a predetermined minimum speed, such as 5 mph, to prevent division by a small number. In this non-limiting embodiment, three models are used to estimate the vehicle yaw rate r, the vehicle lateral acceleration a_{y} and the difference between the front and rear road wheel angles. In this embodiment, the vehicle is a front-wheel drive vehicle and includes two rear-wheel steering actuators for independently steering the rear wheels. The rear wheel speeds are used to estimate the vehicle yaw rate.

Table 1 below shows the model equations for each of the yaw rate estimate, the lateral acceleration estimate and the road wheel angle (RWA) difference estimate. In these equations, ν^{RR} is the rear-right wheel speed, ν_{RL} is the rear-left wheel speed, 2t is the width of the vehicle, u is the vehicle speed, δ_{f} is the front wheel road angle, δᵣᵣ is the right rear wheel road angle, δ^{rl} is the left rear wheel road angle and k is a coefficient. The actual measurements of the yaw rate r and the lateral acceleration a_{y} are also used in the estimation models from the sensors. If the vehicle includes redundant sensors, only signals from the main sensors are used as the actual measurement in the yaw rate, lateral acceleration and road wheel angle difference model equations. This reduces the numerical computation and threshold membership function calibration. Other estimation methods can also be used that include parameter estimation and observers within the scope of the present invention.

In this embodiment, the vehicle is a by-wire vehicle in that electrical signals are used to provide traction drive signals and steering signals to the vehicles wheels. However, this is by way of a non-limiting example in that the system is applicable to be used in other types of vehicles that are not by-wire vehicles.

TABLE 1

| | |
|---|---|
| Model 1 (Yaw Rate Estimate \hat{r}) | $\hat{r} = \frac{{v}_{RR} - {v}_{RL}}{2 t}$ |
| Model 2 | \hat{α}_{y} = ru |
| (Lateral Acceleration Estimate \hat{α}_{y}) | |
| Model 3 (Road Wheel Angle Difference Estimate) | 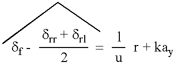 |

The algorithm then determines residual values or errors (difference) between the estimates from the models and the measured values at box 18. One example of the residual calculations is shown in Table 2, where four residuals are generated. The first three residuals for the lateral acceleration, the yaw rate and the RWA difference (Rₐ_{_{y}}, Rᵣ and R₆₇ _{_{f}}_{-δ}_{ᵣ}) are based on the estimation model equations in Table 1. The fourth residual R provides a combined error signal for all of the wheel speeds, as would be particularly applicable in a by-wire vehicle system.

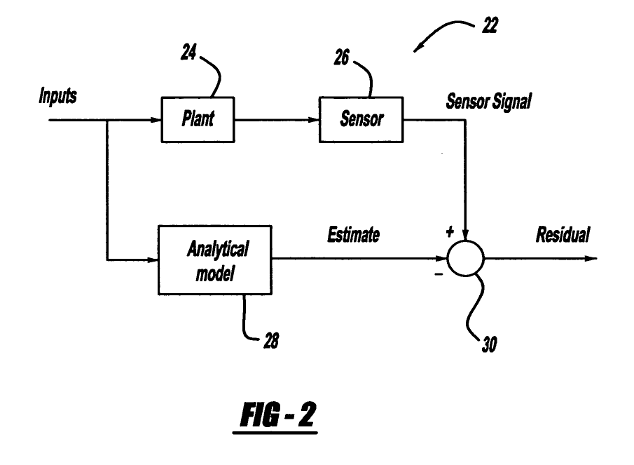

FIG. 2 is a block diagram of a system 22 for determining the residuals based on a difference calculator. Inputs are applied to an actual plant 24 and then to a sensor 26, representing any of the sensors discussed above, to generate the actual measured sensor signal. The inputs are also applied to an analytical model processor 28 to generate the estimate for each of the yaw rate r, the lateral acceleration a_{y} and the road wheel angle difference δ_{f}−δᵣ from the model equations above. The sensor signal from the sensor 26 and the estimate from the analytical model processor 28 are then compared by a comparator 30 that generates the residual for the particular sensor and the particular estimate model.

TABLE 2

| | |
|---|---|
| Rₐ_{_{y}} | α_{y} − \hat{α}_{y} |
| (Lateral | |
| Accelera- | |
| tion) | |
| Rᵣ | r − \hat{r} |
| (yaw rate) | |
| R_{δ}_{_{f}}_{-δ}_{ᵣ}(Road wheel angles) | 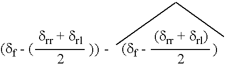 |
| R | $\begin{matrix}- [ \vert {v}_{RR} - \frac{{v}_{FR} + {v}_{FL}}{2} \vert > Th 1 ] - 0.5 [ \vert {v}_{RL} - \frac{{v}_{FR} + {v}_{FL}}{2} \vert > Th 1 ] \\ - [ \vert {δ}_{rr} - ( {δ}_{f} - \frac{1}{u} r - {ka}_{y} ) \vert > Th 2 ] \cdot [ \vert {δ}_{rr} - {δ}_{rl} \vert > Th 3 ] \\ - 0.5 [ \vert {δ}_{rl} - ( {δ}_{f} - \frac{1}{u} r - {ka}_{y} ) \vert > Th 2 ] \cdot [ \vert {δ}_{rr} - {δ}_{rl} \vert > Th 3 ] \\ + 0.5 [ \vert {R}_{ay} \vert > Th 4 ] \cdot [ \vert {R}_{r} \vert \leq Th 5 ] \\ + [ \vert {R}_{r} \vert > Th 5 ] NOR ( [ \vert {v}_{RR} - \frac{{v}_{FR} + {v}_{FL}}{2} \vert > Th 1 ] , \\ [ \vert {v}_{RL} - \frac{{v}_{FR} + {v}_{FL}}{2} > \vert Th 1 ] )\end{matrix}$ |

Note:
[a > b] has a value 1 if a > b and 0 otherwise.

Note: [a>b] has a value 1 if a>b and 0 otherwise.

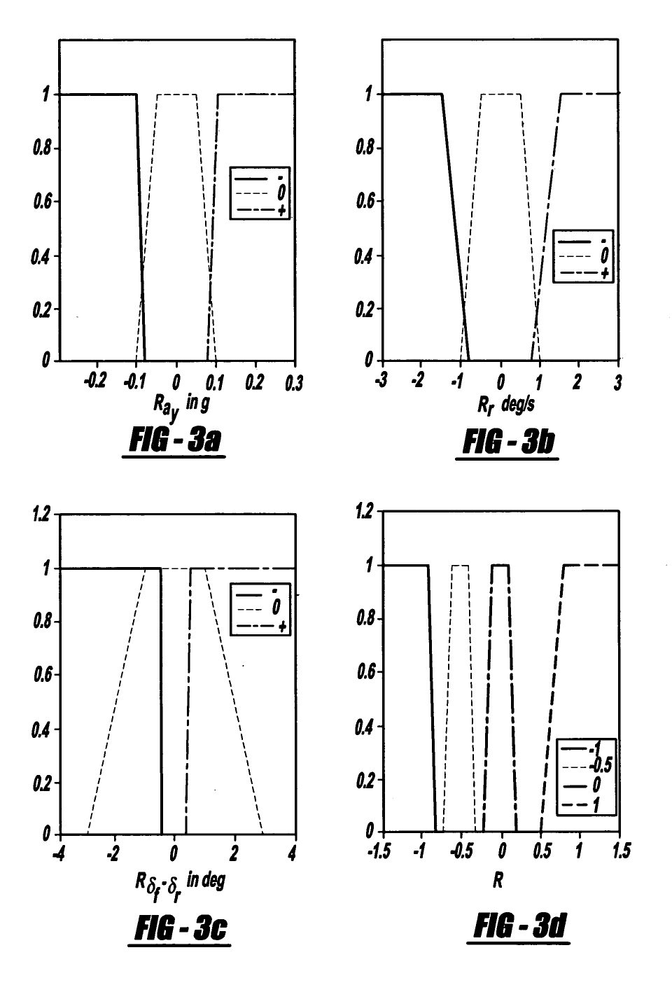

According to fuzzy-logic systems, membership functions define a degree of membership for residual variables. Membership functions 0, + and − for each of the residuals Rₐ_{_{y}}, Rᵣ, R_{δ}_{_{f}}_{-δ}_{ᵣ} and membership functions−1, −0.5, 0, 1 for the residual R are shown in the graphs of FIGS. 3a-3d. Particularly, FIG. 3a shows exemplary membership functions +, −, 0 for the lateral acceleration residual Rₐ_{_{y}}, FIG. 3b shows exemplary membership functions −, 0, + for the yaw rate residual R., FIG. 3c shows exemplary membership functions −, 0, + for the RWA difference residual R_{δ}_{_{f}}−_{δ}_{ᵣ} and FIG. 3d shows exemplary membership functions −1, −0.5, 0, 1 for the combined residual R. The algorithm determines the degree of membership value for each of the membership functions for each residual at box 34. Particularly, a residual degree of membership value on the vertical axis of the graphs is provided for each membership function. Thus, for the residuals Rₐ_{_{y}}, Rᵣ, R_{δ}_{_{f}}_{-δ}_{ᵣ} and R, there are thirteen degree of membership values. The shape of the membership functions shown in FIGS. 3a-3d are application specification in that the membership functions can have any suitable shape depending on the sensitivity of the fault isolation detection desired for a particular vehicle.

Table 3 below gives fourteen faults for the lateral acceleration sensor, the yaw rate sensor, the road wheel angle sensors and the wheel speed sensors. This is by way of a non-limiting example in that other systems may identify other faults for other components or a different number of faults. In each column, a particular membership function is defined for each of the residuals Rₐ_{_{y}}, Rᵣ, R_{δ}_{_{f}}_{-δ}_{ᵣ} and R for each fault. Particularly, for each fault, one of the membership functions is used for each residual. Therefore, one degree of membership value is defined for each residual from the membership function. The value “d” is a “don't care” value, i.e., the residual does not matter.

TABLE 3

Residuals

| Faults | R_{α}_{y} | Rᵣ | R_{δ}_{_{f}}_{-δ}_{ᵣ} | R |
|---|---|---|---|---|
| α_{y} + Δα_{y} | + | 0 | d | 0.5 |
| α_{y} − Δα_{y} | − | 0 | d | 0.5 |
| r + Δr | d | + | d | 1 |
| r − Δr | d | − | d | 1 |
| δ_{f} + Δδ_{f} | 0 | 0 | + | 0 |
| δ_{f} − Δδ_{f} | 0 | 0 | − | 0 |
| δᵣᵣ + Δδᵣᵣ | 0 | 0 | − | −1 |
| δᵣᵣ − Δδᵣᵣ | 0 | 0 | + | −1 |
| δᵣₗ + Δδᵣₗ | 0 | 0 | − | −0.5 |
| δᵣₗ − Δδᵣₗ | 0 | 0 | + | −0.5 |
| ν_{RR} + Δν_{RR} | 0 | − | 0 | −1 |
| ν_{RR} − Δν_{RR} | 0 | + | 0 | −1 |
| ν_{RL} + Δν_{RL} | 0 | + | 0 | −0.5 |
| ν_{RL} − Δν_{RL} | 0 | − | 0 | −0.5 |

Fuzzy-rules define the fuzzy implementation of the fault symptoms relationships. Table 4 below gives a representative example of the fuzzy-rules, for this non-limiting embodiment. Each fault from Table 3 produces a unique pattern of residuals as shown in the Table 4, where it can be seen that the source, location and type of default can be determined. The output of each rule defines a crisp number, such as according to the general Sugeno fuzzy system, that can be interpreted as the probability of the occurrence of that specific fault. The fuzzy reasoning system being described herein can be interpreted as the fuzzy implementation of threshold values. The system increases the robustness of the diagnostics for both signal errors and model inaccuracies, and thus reduces false alarms. The system will also increase the sensitivity to faults that can endanger vehicle stability and safety performance.

For each fault, a degree of membership value is assigned to each residual, as discussed above, and the lowest degree of membership value of the four possible degree of membership values is assigned the degree of membership value for that possible fault. Once each row (fault) has been assigned the minimum degree of membership value for that fault, then the algorithm chooses the largest of the fourteen minimum degree of membership values as the output of the fuzzy system at box 38. The system only identifies one fault at a time.

TABLE 4
If (R_{α}_{y} = ”+”) and (Rᵣ =”0”) and (R_{δ}_{f}−δᵣ = ”d”) and (R =”1”) then ((α_{y} − Δα_{y}) =1)
If (R_{α}_{y} = ”−”) and (Rᵣ =”0”) and (R_{δ}_{f}−δᵣ = ”d”) and (R =”1”) then ((a_{y}−Δa_{y}) =1)
If (R_{α}_{y} = ”−”) and (Rᵣ =”+”) and (R_{δ}_{f}−δᵣ = ”d”) and (R =”1”) then ((r+Δr) =1)
If (R_{α}_{y} = ”+”) and (Rᵣ =”−”) and (R_{δ}_{f}−δᵣ = ”d”) and (R =”1”) then ((r−Δr) =1)
If (R_{α}_{y} = ”0”) and (Rᵣ =”0”) and (R_{δ}_{f}−δᵣ = ”+”) and (R =”0”) then (δ_{f} + Δδ_{f}) =1)
If (R_{α}_{y} = ”0”) and (Rᵣ =”0”) and (R_{δ}_{f}−δᵣ = ”−”) and (R =”0”) then (δ_{f} − Δδ_{f}) =1)
If (R_{α}_{y} = ”0”) and (Rᵣ =”0”) and (R_{δ}_{f}−δᵣ = ”−”) and (R =”−1”) then (δᵣᵣ + Δδᵣᵣ) =1)
If (R_{α}_{y} = ”0”) and (Rᵣ =”0”) and (R_{δ}_{f}−δᵣ = ”+”) and (R =”−1”) then (δᵣᵣ − Δδᵣᵣ) =1)
If (R_{α}_{y} = ”0”) and (Rᵣ =”0”) and (R_{δ}_{f}−δᵣ = ”−”) and (R =”−0.5”) then (δᵣₗ + Δδᵣₗ) =1)
If (R_{α}_{y} = ”0”) and (Rᵣ =”0”) and (R_{δ}_{f}+δᵣ = ”+”) and (R =”−0.5”) then (δᵣₗ − Δδᵣₗ) =1)
If (R_{α}_{y} = ”0”) and (Rᵣ =”−”) and (R_{δ}_{f}−δᵣ = ”0”) and (R =”−1”) then (ν_{RR} + Δν_{RR}) =1)
If (R_{α}_{y} = ”0”) and (Rᵣ =”+”) and (R_{δ}_{f}−δᵣ = ”0”) and (R =”−1”) then (ν_{RR} − Δν_{RR}) =1)
If (R_{α}_{y} = ”0”) and (Rᵣ =”+”) and (R_{δ}_{f}−δᵣ = ”0”) and (R =”−0.5”) then (ν_{RL} + Δν_{RL}) =1)
If (R_{α}_{y} = ”0”) and (Rᵣ =”−”) and (R_{δ}_{f}−δᵣ = ”0”) and (R =”−0.5”) then (ν_{RL} − Δν_{RL}) =1)

The algorithm then determines if the maximum degree of membership value is less than 0.5 at decision diamond 40. It is noted that the value 0.5 is an arbitrary example in that any percentage value can be selected for this value depending on the specific system response and fault detection. If the maximum degree of membership value is greater than 0.5, then the algorithm determines the corresponding fault at box 42, and then, based on the fault source, goes into a fail-safe/or fail-tolerant operation strategy at box 44. If the maximum degree of membership value is less than 0.5 at the decision diamond 40, then the algorithm determines that the system has no problems and has a good state of health at box 46, and continues with monitoring the state of health at box 48.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for detecting a fault in a vehicle control system, said method comprising:
identifying a plurality of potential faults;
identifying a plurality of measured values in the control system;
identifying a plurality of estimated values based on models in the control system;
identifying a plurality of residual error values as the difference between the estimated values and the measured values;
defining a plurality of membership functions for each residual error value;
determining a degree of membership value for each residual error value based on the degree of membership functions; and
determining whether a fault exists by analyzing the degree of membership values.

2. The method according to claim 1 wherein identifying a plurality of potential faults includes identifying faults related to a lateral acceleration sensor, a yaw rate sensor, road wheel angle sensors and wheel speed sensors.

3. The method according to claim 1 wherein identifying a plurality of measured values includes identifying a vehicle yaw rate, a vehicle lateral acceleration and a road wheel angle difference between a front wheel of the vehicle and a rear wheel of the vehicle.

4. The method according to claim 1 wherein identifying a plurality of residual error values includes defining four residual error values as a difference between a measured vehicle lateral acceleration signal and an estimated lateral acceleration signal, a measured yaw rate signal and an estimated yaw rate signal, a measured road wheel angle difference and an estimated road wheel angle difference and a combined signal for all of the vehicle wheel speeds.

5. The method according to claim I wherein defining a plurality of membership functions includes defining at least three membership functions for each residual error value.

6. The method according to claim I wherein determining a degree of membership value for each residual error value includes assigning-one of the degree of membership values to each residual for each potential fault.

7. The method according to claim 1 wherein determining whether a fault exists includes determining whether a particular set of degree of membership values exceeds a predetermined threshold in a certain pattern.

8. The method according to claim I further comprising putting the vehicle in a fail-safe mode of operation if a fault is detected.

9. A method for detecting a fault in a vehicle control system, said method comprising:
identifying a plurality of potential faults;
identifying a plurality of measured values in the control system;
identifying a plurality of estimated values based on models in the control system;
identifying a plurality of residual error values as the difference between the estimated values and the measured values;
defining at least three membership functions for each residual error value;
determining a degree of membership value for each residual error value including assigning one of the degree of membership values to each residual for each potential fault; and
determining whether a fault exists by analyzing the degree of membership values, wherein determining whether a fault exists includes determining whether a particular set of degree of membership values exceeds a predetermined threshold in a certain pattern.

10. The method according to claim 9 wherein identifying a plurality of potential faults includes identifying faults related to a lateral acceleration sensor, a yaw rate sensor, road wheel angle sensors and wheel speed sensors.

11. The method according to claim 10 wherein identifying a plurality of measured values includes identifying a vehicle yaw rate, a vehicle lateral acceleration and a road wheel angle difference between a front wheel of the vehicle and a rear wheel of the vehicle.

12. The method according to claim 11 wherein identifying a plurality of residual error values includes defining four residual error values as a difference between a measured vehicle lateral acceleration signal and an estimated lateral acceleration signal, a measured yaw rate signal and an estimated yaw rate signal, a measured road wheel angle difference and an estimated road wheel angle difference and a combined signal for all of the vehicle wheel speeds.

13. A system for detecting a fault in a vehicle control system, said system comprising:
means for identifying a plurality of potential faults;
means for identifying a plurality of measured values in the control system;
means for identifying a plurality of estimated values based on models in the control system;
means for identifying a plurality of residual error values as the difference between the estimated values and the measured values;
means for defining a plurality of degree of membership functions for each residual error value;
means for determining a degree of membership value for each residual error value based on the membership functions; and
means for determining whether a fault exists by analyzing the degree of membership values.

14. The system according to claim 13 wherein the means for identifying a plurality of potential faults includes means for identifying faults related to a lateral acceleration sensor, a yaw rate sensor, road wheel angle sensors and wheel speed sensors.

15. The system according to claim 13 wherein the means for identifying a plurality of measured values includes means for identifying a vehicle yaw rate, a vehicle lateral acceleration and a road wheel angle difference between a front wheel of the vehicle and a rear wheel of the vehicle.

16. The system according to claim 13 wherein the means for identifying a plurality of residual error values includes means for defining four residual error values as a difference between a measured vehicle lateral acceleration signal and an estimated lateral acceleration signal, a measured yaw rate signal and an estimated yaw rate signal, a measured road wheel angle difference and an estimated road wheel angle difference and a combined signal for all of the vehicle wheel speeds.

17. The system according to claim 13 wherein the means for defining a plurality of membership functions includes means for defining at least three membership functions for each residual error value.

18. The system according to claim 13 wherein the means for determining a membership value for each residual error value includes means for assigning one of the degree of membership values to each residual for each potential fault.

19. The system according to claim 13 wherein the means for determining whether a fault exists includes means for determining whether a particular set of degree of membership values exceeds a predetermined threshold in a certain pattern.

20. The system according to claim 13 further comprising means for putting the vehicle in a fail-safe mode of operation if a fault is detected.

21. The system according to claim 13 wherein the vehicle is a by-wire vehicle.
